(19) United States
(12) Patent Application Publication
(10) Pub. No.: US 2007/0139204 A1
(43) Pub. Date: Jun. 21, 2007

(54) Ear thermometer having the RFID reading function

(76) Inventors: Vincent Weng, HsinChu (TW); James Huang, HsinChu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/527,508

(22) Filed: Sep. 27, 2006

(30) Foreign Application Priority Data
Dec. 16, 2005 (TW) 94144708

(51) Int. Cl. G08B 13/14; G01K 1/00

(52) U.S. Cl. 340/572.8; 374/100

(57) ABSTRACT

An ear thermometer having the RFID reading function comprises an ear thermometer body, a display unit, an RFID reading key and a temperature detection unit. The ear thermometer can read an RFID tag of a subject and detect his ear temperature. The RFID tag and the measured ear temperature of the subject can be simultaneously displayed on the display unit of the ear thermometer. Moreover, the ear thermometer can store and call out several groups of RFID tags and temperature measurement results of different subjects.

### BACKGROUND OF THE INVENTION

1. Field of the Invention

The present invention relates to an ear thermometer and, more particularly, to an ear thermometer having the RFID reading function, which can store and call out several groups of RFID tags and temperature measurement results of different subjects.

2. Description of Related Art

Recently, using ear thermometers for measuring the body temperature has become more and more popular because of more convenient and sanitary in operation as compared to the conventional mercury thermometers.

Conventionally, when a medical personnel wants to measure the body temperatures of several subjects, however, he/she has to bring paper-form medical records of these subjects and then fills the temperatures measured by the ear thermometer on these paper-form medical records respectively. This not only will cause much inconvenience of the medical personnel to bring several paper-form medical records, but he/she also has to check the medical record number of every subject. Moreover, the situation of erroneous recording of data may occur.

Accordingly, the present invention aims to solve the above problems in the prior art.

### SUMMARY OF THE INVENTION

An object of the present invention is to provide an ear thermometer having the RFID reading function, which can read an RFID tag of a subject whose temperature is to be measured, and then simultaneously display the RFID tag and the temperature measurement result on a display of the ear thermometer when measuring the temperature of the subject.

Another object of the present invention is to provide an ear thermometer having the RFID reading function, which can memorize and call out several groups of RFID tags and temperature measurement results of different subjects.

To achieve the above objects, the present invention utilizes an ear thermometer body, which has a display unit, an RFID reading key, a temperature detection key and a temperature detection unit. The temperature detection unit is located at the front end of the top of the ear thermometer body. The ear thermometer body has a microprocessor therein. The microprocessor is connected to an RFID reading unit, the RFID reading key, the display unit, the temperature detection key, the temperature detection unit and a memory. When the RFID reading key is pressed down, the microprocessor immediately activates the RFID reading unit to read an RFID tag of a subject whose temperature is to be measured and displays the RFID tag on the display unit. Next, when the temperature detection key is pressed down, the microprocessor activates the temperature detection unit to measure the ear temperature of the subject and displays the temperature measurement result on the display unit. The RFID tag and temperature measurement result of the subject are sent to the microprocessor, then displayed on the display unit, and then stored in the memory. Moreover, the memory can store a plurality of groups of RFID tags and temperature measurement results of different subjects for later call-out of data to facilitate the recording of data.

### BRIEF DESCRIPTION OF THE DRAWINGS

The various objects and advantages of the present invention will be more readily understood from the following detailed description when read in conjunction with the appended drawing, in which:

FIG. 1A is a side view of the present invention;

FIG. 1B is a front view of the present invention; and

FIG. 2 is a system block diagram of the present invention.

### DETAILED DESCRIPTION OF THE PREFERRED EMBODIMENTS

The present invention discloses an ear thermometer having the RFID reading function, which can simultaneously display an RFID tag and a temperature measurement result of a subject on a display of the ear thermometer, and can also store data of several subjects.

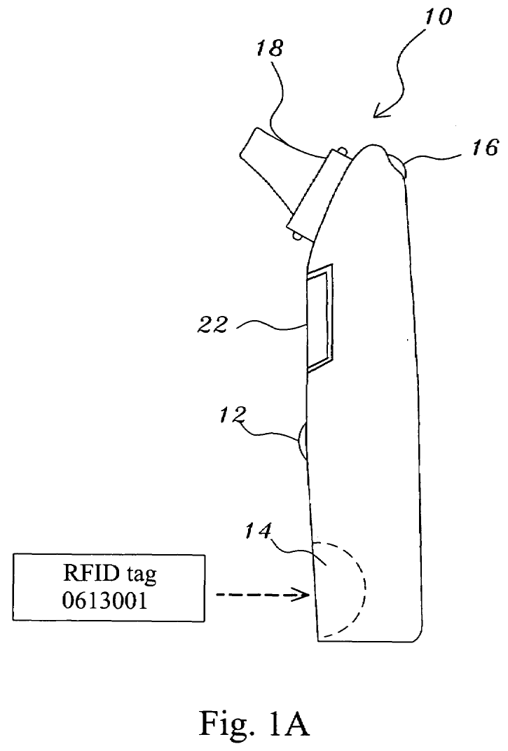

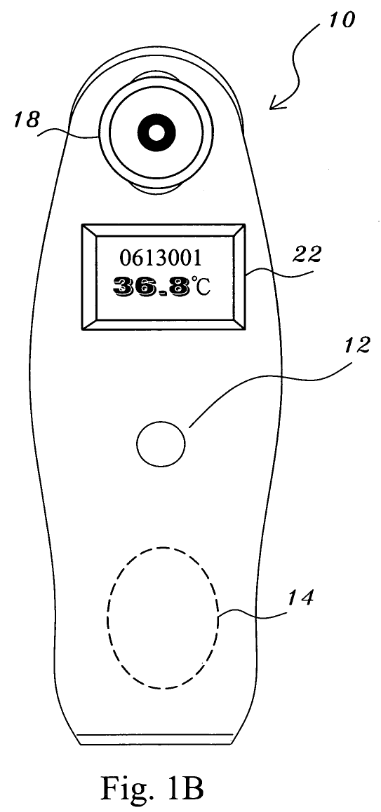

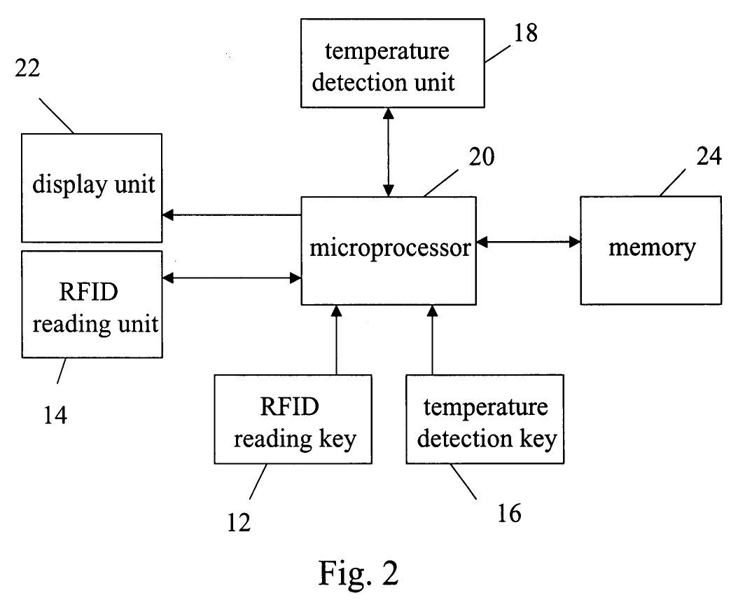

As shown in FIGS. 1A, 1B and 2, the present invention comprises an ear thermometer body 10, an RFID reading unit 14 for reading an RFID tag of a subject, a temperature detection unit 18 located at the front end of the top of the ear thermometer body 10 and used to measure the temperature of the subject, a microprocessor 20 connected to the RFID reading unit 14, the temperature detection unit 18 and a memory 24, and a display unit 22 located on the ear thermometer and connected to the microprocessor 20 and used to display the RFID tag and the temperature measurement result of the subject. When an RFID reading key 12 is pressed down, the RFID reading unit 14 is immediately controlled by the microprocessor 20 to start reading the RFID tag of the subject. The RFID tag is sent to the microprocessor 20 and displayed on the display unit 22. Next, when a temperature detection key 16 is pressed down, the temperature detection unit 18 is immediately controlled by the microprocessor 20 to start measuring the ear temperature of the subject. The temperature measurement result is sent to the microprocessor 20 and also displayed on the display unit 22. At this time, the display unit 22 displays the RFID tag and the temperature measurement result of the subject, as shown in FIG. 1B. The RFID tag and the temperature measurement result of the subject are sent to the microprocessor 20 to be stored in the memory 24. The RFID tag can be designed to be embedded in a long ring-shaped ID band that is worn on a wrist of the subject. The memory 24 can store a plurality of groups of RFID tags and temperature measurement results of different subjects. The display unit 22 is a liquid crystal display.

According to a preferred embodiment, when a medical personnel wants to measure the temperatures of several patients, he/she first presses down the RFID reading key 12 to activate the RFID reading unit 14 so as to read an RFID tag embedded on a long ring-shaped ID band that is worn on a wrist of one patient. The RFID tag is a medical record number of the patient. Next, he/she presses down the temperature detection key 16 to activate the temperature detection unit 18 so as to measure the ear temperature of the patient. The medical record number and the temperature measurement result of the patient will be simultaneously displayed on the liquid crystal display of the ear thermometer. After the measurement of all the patients is finished, the medical personnel goes back to the medical station, calls out the medical record numbers and the temperature measurement results of all the patients stored in the ear thermometer, and fills the data in paper-form medical records of these patients.

To sum up, in the prior art, when a medical personnel wants to measure the body temperatures of several patients, he/she has to bring paper-form medical records of the patients, then checks whether the patients' information match the paper-form medical records or not, and then fills the temperatures measured by the ear thermometer on the paper-form medical records one by one. Moreover, if there are many patients needed to be measured temperature on the spot, the situation of erroneous recording of data may easily occur. The ear thermometer having the RFID reading function of the present invention can solve the above problems. The medical personnel does not have to bring paper-form medical records of the patients and to check whether the patients' information match the paper-form medical records or not, and then fill the temperatures measured by the ear thermometer on the paper-form medical records one by one. Instead, the medical personnel can go back to the medical station, call out the medical record numbers and the temperature measurement results of all the patients stored in the ear thermometer, and fill the data in the paper-form medical records of these patients after the measurement of all the patients is finished. Therefore, the convenience in use can be much enhanced.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An ear thermometer having the RFID reading function comprising:
an ear thermometer body;
an RFID reading unit for reading an RFID tag of a subject whose temperature is to be measured;
a temperature detection unit located at a front end of a top of said ear thermometer and used to measure the temperature of said subject;
a microprocessor connected to said RFID reading unit and said temperature detection unit, said RFID reading unit being controlled by said microprocessor to start reading said RFID tag of said subject after a measurer presses an RFID reading key, said microprocessor then activating said temperature detection unit to measure the temperature of said subject after said measurer presses a temperature detection key, said RFID tag of said subject and a temperature measurement result being finally sent to said microprocessor; and
a display unit located on said ear thermometer body and connected to said microprocessor, said display unit being used to display said RFID tag and said temperature measurement result.

2. The ear thermometer having the RFID reading function as claimed in claim 1, wherein said RFID tag can be a medical record number of said subject.

3. The ear thermometer having the RFID reading function as claimed in claim 1, wherein said RFID tag can be embedded in a long ring-shaped ID band that is worn on the body of said subject.

4. The ear thermometer having the RFID reading function as claimed in claim 1, wherein said microprocessor is connected to a memory for storing said RFID tag and said temperature measurement result for later call-out and inquiry.

5. The ear thermometer having the RFID reading function as claimed in claim 4, wherein said memory can store a plurality of groups of RFID tags and temperature measurement results of different subjects.

6. The ear thermometer having the RFID reading function as claimed in claim 1, wherein said display unit is a liquid crystal display unit.
